(19) United States
(12) Patent Application Publication
(10) Pub. No.: US 2020/0362997 A1
(43) Pub. Date: Nov. 19, 2020

(54) INSULATED CONNECTOR COMPONENTS

(71) Applicant: CONCEPT GROUP LLC, Wellesley, MA (US)

(72) Inventor: Aarne H. REID, Jupiter, FL (US)

(21) Appl. No.: 16/763,592

(22) PCT Filed: Nov. 14, 2018
(86) PCT No.: PCT/US2018/061054

§ 371 Date: May 13, 2020

Related U.S. Application Data
(60) Provisional application No. 62/585,744, filed on Nov. 14, 2017.

(51) Int. Cl. F16L 21/00; F16L 59/065; F16L 59/18

(52) U.S. Cl. CPC F16L 21/007; F16L 59/182; F16L 59/065

(57) ABSTRACT

Provided are insulated assemblies that reduce heat transfer to the environment at the junction of two lumens, the assemblies comprising an insulated jacket that can be secured to the lumens so as to enclose the junction between the two lumens. Also provided are related methods of fabricating such assemblies.

### RELATED APPLICATION

The present application claims priority to and the benefit of U.S. patent application No. 62/585,744, “Insulated Connector Components” (filed Nov. 14, 2017), which application is incorporated by reference herein in its entirety for any and all purposes.

### TECHNICAL FIELD

The present application relates to the field of vacuum-insulated components and to the field of tube-to-tube connectors.

### BACKGROUND

In the field of fluid handling, there is a need to carry fluid along a given conduit while also maintaining the temperature of the fluid while the fluid is in transit. Existing technologies for doing so—e.g., linear and curved piping—are formed having a desired shape and are then fixed (e.g., via casting or other molding process) in that shape. Connecting such conduits to one another, however, poses challenges, as an end-to-end connection between conduits presents the possibilities of (1) fluid leakage at the connection; and (2) a loss of insulating capacity at the connection. Accordingly, there is a need in the art for connectors (and related methods) useful in connecting insulated conduits to one another.

### SUMMARY

In meeting the long-felt needs described above, the present disclosure first provides insulated assemblies, comprising: (a) a jacket assembly that comprises (i) an outer jacket secured to a first threaded fitting and (ii) an inner jacket secured to the first threaded fitting, the inner jacket defining a jacket lumen therein, the jacket lumen defining a major axis, the outer jacket and the inner jacket also defining a sealed, evacuated jacket insulating space therebetween, a vent communicating with the jacket insulating space to provide an exit pathway for gas molecules from the jacket insulating space, the vent being sealable for maintaining a vacuum within the jacket insulating space following evacuation of gas molecules through the vent, the distance between the first and second walls optionally being variable in a portion of the jacket insulating space adjacent the vent such that gas molecules within the jacket insulating space are directed towards the vent by the variable-distance portion of the first and second walls during the evacuation of the jacket insulating space, the directing of the gas molecules by the variable-distance portion of the first and second walls imparting to the gas molecules a greater probability of egress from the jacket insulating space than ingress; (b) a first conduit defining a first lumen; (c) a second conduit defining a second lumen, the lumen of the second conduit and the lumen of the first conduit being in fluid communication with one another; and, (d) optionally, a sealer disposed between an end of the first conduit and an end of the second conduit, the sealer being in fluid communication with the first lumen and with the second lumen, and (e) the jacket assembly being sealably secured to the first conduit and the second conduit, and, (f) as measured along the major axis of the lumen of the jacket, the jacket insulating space overlying at least a portion of the first conduit and at least a portion of the second conduit.

Also provided are methods, the methods comprising: communicating a fluid through the lumen of the first conduit and the lumen of the second conduit of an insulated assembly according to the present disclosure.

Further provided are methods, comprising: with (a) a jacket assembly that comprises (i) an outer jacket secured to a first threaded fitting and (ii) an inner jacket secured to the first threaded fitting, the inner jacket defining a jacket lumen therein, the jacket lumen defining a major axis, the outer jacket and the inner jacket also defining a sealed jacket insulating space therebetween, a vent communicating with the jacket insulating space to provide an exit pathway for gas molecules from the jacket insulating space, the vent being sealable for maintaining a vacuum within the jacket insulating space following evacuation of gas molecules through the vent, the distance between the first and second walls optionally being variable in a portion of the jacket insulating space adjacent the vent such that gas molecules within the jacket insulating space are directed towards the vent by the variable-distance portion of the first and second walls during the evacuation of the jacket insulating space, the directing of the gas molecules by the variable-distance portion of the first and second walls imparting to the gas molecules a greater probability of egress from the jacket insulating space than ingress; (b) a first conduit defining a first lumen; (c) a second conduit defining a second lumen, the lumen of the second conduit and the lumen of the first conduit being in fluid communication with one another; and, (d) optionally, a sealer disposed between and end of the first conduit and an end of the second conduit, the sealer being in fluid communication with the first lumen and with the second lumen, placing the first lumen into fluid communication with the second lumen (which can be done sealably), and sealably securing the jacket assembly to one or both of the first and second conduits such that, as measured along the major axis of the lumen of the jacket, the jacket insulating space overlies at least a portion of the first conduit and at least a portion of the second conduit.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1 provides an exterior view of an exemplary insulated assembly according to the present disclosure; and

FIG. 2 provides a simplified exterior view of an assembly of multiple, insulated conduits according to the present disclosure.

### DETAILED DESCRIPTION OF ILLUSTRATIVE EMBODIMENTS

The present disclosure may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable, and it should be understood that steps can be performed in any order.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. Further, reference to values stated in ranges include each and every value within that range. In addition, the term “comprising” should be understood as having its standard, open-ended meaning, but also as encompassing “consisting” as well. For example, a device that comprises Part A and Part B can include parts in addition to Part A and Part B, but can also be formed only from Part A and Part B.

As explained in U.S. Pat. No. 7,681,299 and 7,374,063 (incorporated herein by reference in their entireties for any and all purposes), the geometry of an insulating space can be such that it guides gas molecules within the space toward a vent or other exit from the space. The width of the vacuum insulating space need not be not uniform throughout the length of the space. The space can include an angled portion such that one surface that defines the space converges toward another surface that defines the space. As a result, the distance separating the surfaces can vary adjacent the vent such the distance is at a minimum adjacent the location at which the vent communicates with the vacuum space. The interaction between gas molecules and the variable-distance portion during conditions of low molecule concentration serves to direct the gas molecules toward the vent.

The molecule-guiding geometry of the space provides for a deeper vacuum to be sealed within the space than that which is imposed on the exterior of the structure to evacuate the space. This somewhat counterintuitive result of deeper vacuum within the space is achieved because the geometry of the present invention significantly increases the probability that a gas molecule will leave the space rather than enter. In effect, the geometry of the insulating space functions like a check valve to facilitate free passage of gas molecules in one direction (via the exit pathway defined by vent) while blocking passage in the opposite direction.

Another benefit associated with the deeper vacuums provided by the geometry of insulating space is that it is achievable without the need for a getter material within the evacuated space. The ability to develop such deep vacuums without a getter material provides for deeper vacuums in devices of miniature scale and devices having insulating spaces of narrow width where space constraints would limit the use of a getter material.

Other vacuum-enhancing features can also be included, such as low-emissivity coatings on the surfaces that define the vacuum space. The reflective surfaces of such coatings, generally known in the art, tend to reflect heat-transferring rays of radiant energy. Limiting passage of the radiant energy through the coated surface enhances the insulating effect of the vacuum space.

In some embodiments, an article can comprise first and second walls spaced at a distance to define an insulating space therebetween and a vent communicating with the insulating space to provide an exit pathway for gas molecules from the insulating space. The vent is sealable for maintaining a vacuum within the insulating space following evacuation of gas molecules through the vent. The distance between the first and second walls is variable in a portion of the insulating space adjacent the vent such that gas molecules within the insulating space are directed towards the vent during evacuation of the insulating space. The direction of the gas molecules towards the vent imparts to the gas molecules a greater probability of egress than ingress with respect to the insulating space, thereby providing a deeper vacuum without requiring a getter material in the insulating space.

The construction of structures having gas molecule guiding geometry according to the present invention is not limited to any particular category of materials. Suitable materials for forming structures incorporating insulating spaces according to the present invention include, for example, metals, ceramics, metalloids, or combinations thereof.

The convergence of the space provides guidance of molecules in the following manner. When the gas molecule concentration becomes sufficiently low during evacuation of the space such that structure geometry becomes a first order effect, the converging walls of the variable distance portion of the space channel gas molecules in the space toward the vent. The geometry of the converging wall portion of the vacuum space functions like a check valve or diode because the probability that a gas molecule will leave the space, rather than enter, is greatly increased.

The effect that the molecule-guiding geometry of structure has on the relative probabilities of molecule egress versus entry may be understood by analogizing the converging-wall portion of the vacuum space to a funnel that is confronting a flow of particles. Depending on the orientation of the funnel with respect to the particle flow, the number of particles passing through the funnel would vary greatly. It is clear that a greater number of particles will pass through the funnel when the funnel is oriented such that the particle flow first contacts the converging surfaces of the funnel inlet rather than the funnel outlet.

Various examples of devices incorporating a converging wall exit geometry for an insulating space to guide gas particles from the space like a funnel are provided herein. It should be understood that the gas guiding geometry of the invention is not limited to a converging-wall funneling construction and can, instead, utilize other forms of gas molecule guiding geometries. Some exemplary vacuum-insulated spaces (and related techniques for forming and using such spaces) can be found in United States published patent applications 2017/0253416; 2017/0225276; 2017/0120362; 2017/0062774; 2017/0043938; 2016/0084425; 2015/0260332; 2015/0110548; 2014/0090737; 2012/0090817; 2011/0264084; 2008/0121642; and 2005/0211711, all by A. Reid, and all incorporated herein by reference in their entireties for any and all purposes. Such a space can be termed an InsulonTM space.

Figures

Provided here is additional detail concerning the attached, non-limiting figures.

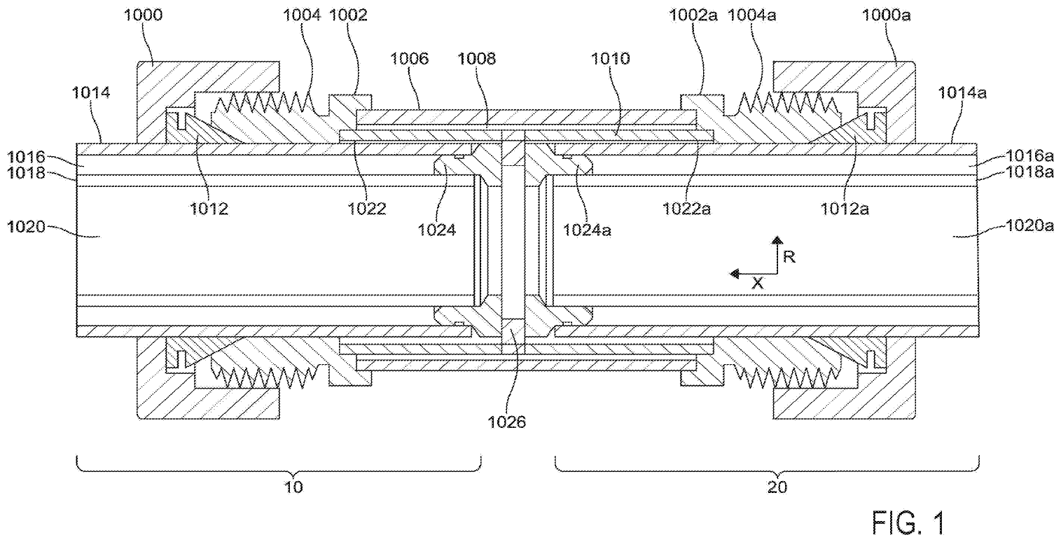

FIG. 1 provides a non-limiting, cutaway illustration of an article according to the present disclosure. As shown in FIG. 1, a jacket can be used to form an insulated fluidic connection between first conduit 10 and second conduit 20.

As shown, first conduit 10 can include an inner tube 1018 and outer tube 1014. A sealed evacuated insulating space 1016 is defined between inner tube 1018 and outer tube 1014. Inner tube 1018 can define a lumen 1020 therein.

Suitable methods for forming such insulated spaces can be found in the various documents by Reid, cited elsewhere herein; as described in the documents by Reid, sealed insulating space 1016 can include a vent formed by a variable distance between the inner tube and outer tube such that the distance between the first and second walls is variable in a portion of the insulating space adjacent the vent such that gas molecules within the insulating space are directed towards the vent during evacuation of the insulating space. The direction of the gas molecules towards the vent imparts to the gas molecules a greater probability of egress than ingress with respect to the insulating space, thereby providing a deeper vacuum without requiring a getter material in the insulating space. The convergence of the space provides guidance of molecules in the following manner. When the gas molecule concentration becomes sufficiently low during evacuation of the space such that structure geometry becomes a first order effect, the converging walls of the variable distance portion of the space channel gas molecules in the space toward the vent. The geometry of the converging wall portion of the vacuum space functions like a check valve or diode because the probability that a gas molecule will leave the space, rather than enter, is greatly increased. Such a space can be termed an InsulonTM space. A sealed space can be annular in configuration.

As shown, an assembly according to the present disclosure can also include a second conduit 20. Second conduit 20 can include inner tube 1018a, which inner tube defines lumen 1020a within. The second conduit 20 can also include outer tube 1014a, and a sealed evacuated insulating space 1016a can be defined between outer tube 1014a and inner tube 1018a. Suitable such sealed evacuated insulating spaces can be, e.g., an Insulon™ space.

As shown, a (first) fitting 1024 can be disposed so as to seal the space 1016 between inner tube 1018 and outer tube 1014. Fitting 1024 can include, as shown, a portion (e.g., a flange) that extends into space 1016, although this is not a requirement. The flange can include a curved, angled, tapered, or otherwise shaped region that extends into space 1016. Fitting 1024 can also include a facing portion (not labeled) that faces second conduit 20. The facing portion can be flat or curved. In some embodiments, fitting 1024 includes a feature (e.g., a groove, a ridge, a tab, a flange, and the like) configured to engage with fitting 1024a (described elsewhere herein) or even with sealer 1026 (described elsewhere herein).

Also as shown, a (second) fitting 1024a can be disposed so as to seal the space 1016a between inner tube 1018a and outer tube 1014a, of the second conduit 20. Fitting 1014a can include, as shown, a portion (e.g., a flange) that extends into space 1016a, although this is not a requirement. The flange can include a curved, angled, tapered, or otherwise shaped region that extends into space 1016a. Fitting 1024a can also include a facing portion (not labeled) that faces first conduit 10. The facing portion can be flat or curved. In some embodiments, fitting 1024a includes a feature (e.g., a groove, a ridge, a tab, a flange, and the like) configured to engage with fitting 1024, or even with sealer 1026 (described elsewhere herein). Although not shown in FIG. 1, fittings 1024 and 1024a can be combined into a single fitting to which are sealed outer tubes 104 and 1014a and inner tubes 1018 and 1018a.

As an example (and with reference to FIG. 1), a single fitting may include opposing first and second flanges, with the first flange extending into (and, in some embodiments, sealing) space 1016, and the second flange extending into (and, in some embodiments, sealing) space 1016a.

An assembly according to the present disclosure can also include a jacket assembly. By reference to FIG. 1, a jacket assembly can include a first nut 1000. First nut 1000 can threadably engage with a first ferrule 1012, as well as with second ferrule (also termed a “first threaded fitting”) 1004. First ferrule 1012 can include a sloped or wedged portion (not labeled) that engages directly or indirectly with second ferrule 1004. By way of rotation of nut 1000, first ferrule 1012 is advanced toward second ferrule 1004, thereby effecting compression between first ferrule 1012 and outer tube 1014. First ferrule 1012 can be secured to outer tube 1014. Nut 1000 can be secured to outer tube 1014. Second ferrule 1004 can be secured to outer tube 1014.

Second ferrule 1004 can be sealed to outer jacket 1006 and can also be sealed to inner jacket 1010. A sealed, evacuated insulating space 1008 can be formed between outer jacket 1006 and inner jacket 1010. Suitable such spaces are described elsewhere herein. Second ferrule 1004 can include a portion 1002 that is configured to engage with one or both of outer jacket 1006 and inner jacket 1010. As one example, second ferrule 1004 can include one or more grooves, recesses, or other features into which one or both of outer jacket 1006 and/or inner jacket 1010 fit.

As shown in FIG. 1, space 1008 can enclose the junction between first conduit 10 and second conduit 20. As shown, along the major axis (not shown) in the x-direction of the space 1008, space 1008 encloses the junction between lumen 1020 of the first conduit and lumen 1020a of the second conduit.

By reference to FIG. 1, a jacket assembly can include a second nut 1000a. Second nut 1000a can threadably engage with a fourth ferrule 1004a, as well as with third ferrule 1012a, which can include a sloped or wedged portion (not labeled) that engages with fourth ferrule 1004a. By way of rotation of second nut 1001a, third ferrule 1012a is advanced against second ferrule 1004a, thereby effecting compression between third ferrule 1012a and outer tube 1014a.

Fourth ferrule 1004a can be sealed to outer jacket 1008a and can also be sealed to inner jacket 1010. A sealed, evacuated insulating space 1008a can be formed between outer jacket 1006 and inner jacket 1010. Suitable such spaces are described elsewhere herein. Fourth ferrule 1004a can include a portion 1002 that is configured to engage with one or both of outer jacket 1006 and inner jacket 1010. As one example, threaded portion 1004a can include one or more grooves, recesses, or other features into which one or both of outer jacket 1006 and/or inner jacket 1010 fit. Third ferrule 1012a can be secured to outer tube 1014a. Nut 1000a can be secured to outer tube 1014a. Second ferrule 1004a can be secured to outer tube 1014a.

As shown in FIG. 1, the jacket assembly that comprises outer jacket 1006, inner jacket 1010, and sealed evacuated space 1008 is secured to first conduit 10 and second conduit by moveable compression ferrules that engage with each of first conduit 10 and second conduit 20. In some embodiments, the jacket assembly is secured to at least one of the first conduit 10 and second conduit 20 without the use of a compression ferrule. In one such embodiment, the jacket assembly is secured to the first conduit as shown in FIG. 1, and is secured to the second conduit by, e.g., a braze or other stationary attachment.

Again by reference to FIG. 1, a space 1022 can be defined between inner jacket 1010 and outer tube 1014. Space 1022 can be sealed. Space 1022 can also be at atmospheric pressure; as an example, space 1022 can be filled (and can be sealed) with ambient air so as to provide an insulating “air gap” between the jacket assembly and lumens 1020 and 1020a. Space 1022 can also be evacuated. Similarly, a space 1022a can be defined between inner jacket 1010 and outer tube 1014. Space 1022a can be sealed. Space 1022a can also be at atmospheric pressure; as an example, space 1022a can be filled (and can be sealed) with ambient air so as to provide an insulating air gap between the jacket assembly and lumens 1020 and 1020a. Space 1022a can also be evacuated.

An assembly according to the present disclosure can also include sealer 1026, although this is not a requirement. Sealer 1026 can engage with fitting 1024 and/or 1024a so as to form a fluid-tight seal between lumen 1020 of first conduit 10 and lumen 1020a of second conduit 20. Sealer 1026 can comprise a resilient material, e.g., an elastomeric material. Sealer 1026 can be formed of a polymer and/or a metal. Sealer 1026 can contact inner jacket 1010, but this is not a requirement, as sealer 1026 can be dimensioned such that it does not contact inner jacket 1010.

Sealer 1026 is, however, optional and is not a requirement. As an example (and with reference to FIG. 1), fittings 1024 and 1024a may directly contact one another, thereby giving rise to fluid communication between lumen 1020 and 1020a, which fluid communication can be sealed. One or both of fittings 1024 and 1024a can include an engagement feature (e.g., a tab, a ridge, a slot, a groove, and the like) that engages with the other of fittings 1024 and 1024a. One or more fasteners can also be used to effect fluid communication between first conduit 10 and second conduit 20. As an example, one or more fasteners can be used to secure fitting 1024 and 1024a to one another.

As shown in FIG. 1, an article can define an axial direction X and a radial direction R. Sealer 1026 can define a width Wₛₑₐₗₑᵣ along the axial direction. Insulating space 1008 can define a width W_{insulating} also in the axial direction. In some embodiments, W_{insulating} is greater than Wₛₑₐₗₑᵣ.

Without being bound to any particular theory, a molecule located within an assembly according to the present disclosure crosses at least one sealed evacuated insulating space as that molecule moves radially outward along direction R (by reference to FIG. 1). Again without being bound to any particular theory, the jacket assembly allows for a sealed evacuated insulating layer along the length of each of two conduits as well as at the location where those conduits are joined.

As shown, a user can twist nut 1000 so as to engage the threads of nut 1000 with the threads of first ferrule 1012. Nut 1000 can be, e.g., a polygonal (e.g., hexagonal) nut or other fitting (e.g., a splined nut) that can be installed manually or with an installation tool such as a wrench or other implement. By the action of the thread engagement, first ferrule 1012 is exerted toward second ferrule 1004, which in turn acts to secure outer jacket 1006 and inner jacket 1010 to outer tube 1006.

By reference to exemplary FIG. 1 (and without being bound by any particular theory), the jacket can be secured to the outer tube by way of exertion of ferrule 1012 and ferrule 1012a. First conduit 10 and second conduit can also be exerted against one another by way of exertion of ferrule 1012 and 1012a; this can also include exerting fitting 1024 and fitting 1024a (if present) against one another. Such exertion can form a seal between lumen 1020 and lumen 1020a.

By virtue of a fitting arrangement, outer jacket 1006 and inner jacket 1010 (as well as space 1008) can be positioned so as to provide thermal insulation that encloses the junction of two insulated articles. In this way, the disclosed articles reduce or even eliminate heat transfer associated with the junction between two tubes. By using the disclosed technology, a user can thus form a succession of insulated articles (e.g., tubes) so as to achieve a length (or geometry) of thermally-insulated fluid pathway that can not be easily attained by a single tube unit. The jacket assembly can in turn be installed (e.g., slid) over the junction between two segments of tubing and then secured as described elsewhere herein, e.g., via a fitting arrangement.

In addition to providing thermal insulation nearby to the junction between two conduits, the disclosed jacket assemblies also provide containment for any fluid that might leak from the junction between the two conduits. As described elsewhere herein, a jacket assembly can be sealably secured to one or both conduits, and this sealable securing provides containment for any fluid that may leak from the junction between the conduits.

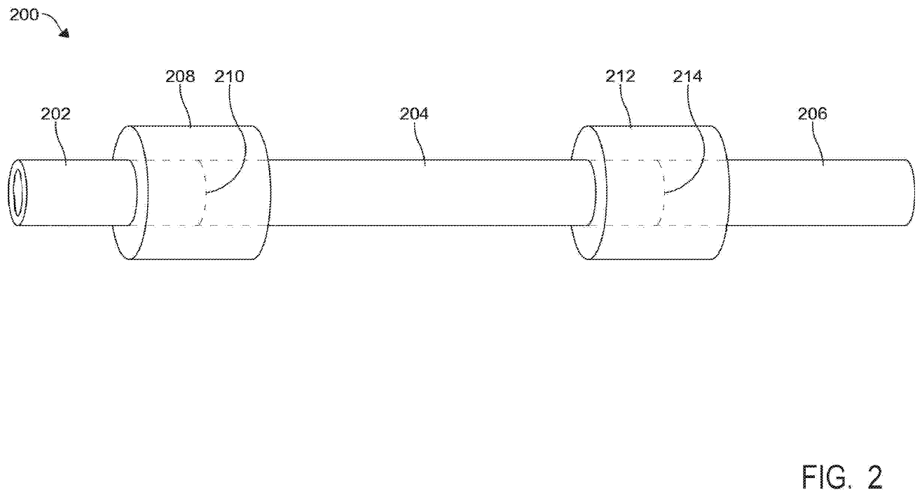

FIG. 2 provides an exemplary, simplified depiction of an arrangement 200 of insulated tube segments according to the present disclosure. As shown in FIG. 2, first jacket assembly 208 is positioned over junction 210 between first tube section 202 and second tube section 204. Similarly, second jacket assembly 212 is positioned over junction 214 between second tube section 204 and third tube section 206. Any of tube sections 202, 204, and 206 can comprise inner and outer walls that define a sealed, insulating space therebetween, as described elsewhere herein. Such a space can be an Insulon™ space. (A jacket assembly can also include a nut, ferrule, or other fitting—for the sake of simplicity, such fittings are not shown in FIG. 2.)

Similarly, any of jacket assemblies 208 and 212 can comprise inner and outer jackets that define a sealed, insulating space therebetween. The sealed space can be, e.g., an Insulon™ space, as described elsewhere herein. Also as described elsewhere herein, arrangement 200 can include a space between the outer tube of a tube segment and the inner jacket of a jacket assembly. This space can be at ambient pressure, but can also be at reduced pressure, and can be formed as an Insulon™ space.

Although FIG. 1 depicts first and second conduits 10 and 20 as being straight, it should be understood that a conduit can include a curved or otherwise nonlinear portion. As one example, a first conduit can include a curved portion and a linear portion, and a user can then connect the linear portion of the first conduit to a second conduit.

### Exemplary Embodiments

The following embodiments are exemplary only and do not serve to limit the scope of the present disclosure or the attached claims.

Embodiment 1. An insulated assembly, comprising: (a) a jacket assembly that comprises (i) an outer jacket secured to a first threaded fitting and (ii) an inner jacket secured to the first threaded fitting, the inner jacket defining a jacket lumen therein, the jacket lumen defining a major axis, the outer jacket and the inner jacket also defining a sealed, evacuated jacket insulating space therebetween, a vent communicating with the jacket insulating space to provide an exit pathway for gas molecules from the jacket insulating space, the vent being sealable for maintaining a vacuum within the jacket insulating space following evacuation of gas molecules through the vent, the distance between the first and second walls optionally being variable in a portion of the jacket insulating space adjacent the vent such that gas molecules within the jacket insulating space are directed towards the vent by the variable-distance portion of the first and second walls during the evacuation of the jacket insulating space, the directing of the gas molecules by the variable-distance portion of the first and second walls imparting to the gas molecules a greater probability of egress from the jacket insulating space than ingress; (b) a first conduit defining a first lumen; (c) a second conduit defining a second lumen, the lumen of the second conduit and the lumen of the first conduit being in fluid communication with one another; and, (d) optionally, a sealer disposed between an end of the first conduit and an end of the second conduit, the sealer being in fluid communication with the first lumen and with the second lumen, and (e) the jacket assembly being sealably secured to the first conduit and the second conduit, and,

(f) as measured along the major axis of the lumen of the jacket, the jacket insulating space overlying at least a portion of the first conduit and at least a portion of the second conduit.

As explained, the distance between the first and second walls can be variable in a portion of the jacket insulating space adjacent the vent such that gas molecules within the jacket insulating space are directed towards the vent by the variable-distance portion of the first and second walls during the evacuation of the jacket insulating space, the directing of the gas molecules by the variable-distance portion of the first and second walls imparting to the gas molecules a greater probability of egress from the jacket insulating space than ingress. This is not a requirement, but it is considered especially suitable. It should be understood that the jacket insulating space can be at ambient pressure (e.g., filled with ambient air or other gas). In some embodiments, the jacket insulating space can be at a reduced pressure, e.g., at a vacuum.

As described elsewhere herein, a jacket assembly can be slid over the conduits and then secured into place. In this way, the present disclosure provides for simplified connections between conduits, as a user can form a junction between the two conduits, e.g., by abutting the conduits' ends against a ring, and then securably sealing the jacket assembly to the conduits so as to provide thermal insulation about the conduits and also fluid containment about the junction between the conduits.

Embodiment 2. The insulated assembly of Embodiment 1, further comprising a first threaded nut that encircles the first conduit and a first ferrule that encircles the first conduit, the first threaded nut engaging with the first threaded fitting such that the first ferrule sealably secures the jacket assembly to the first conduit. As shown in FIG. 1, one or both of the threaded fitting and a ferrule can have an angled portion (e.g., a wedge) that engages with the other.

Embodiment 3. The insulated assembly of any of Embodiments 1-2, wherein the outer jacket is secured to a second threaded fitting and the inner jacket is secured to the second threaded fitting, and wherein the insulated assembly further comprises a second threaded nut that encircles the second conduit and a second ferrule that encircles the second conduit, the second threaded nut engaging with the second threaded fitting such that the second ferrule sealably secures the jacket assembly to the second conduit. Engagement between a ferrule and fitting can be between angled portions of one or both.

Embodiment 4. The insulated assembly of any of Embodiments 1-3, wherein the first and second lumens are coaxial with one another. In some embodiments, the lumens are of the same cross-sectional dimension, although this is not a requirement.

Embodiment 5. The insulated assembly of any of Embodiments 1-4, wherein the first conduit comprises a first inner tube and a first outer tube, the first inner tube and the first outer tube defining a sealed insulating space therebetween.

Embodiment 6. The insulated assembly of Embodiment 5, further comprising a vent communicating with the sealed insulating space of the first conduit so as to provide an exit pathway for gas molecules from the sealed insulating space, the vent being sealable for maintaining a vacuum within the sealed insulating space following evacuation of gas molecules through the vent, the distance between the first and second walls being variable in a portion of the sealed insulating space adjacent the vent such that gas molecules within the sealed insulating space are directed towards the vent by the variable-distance portion of the first and second walls during the evacuation of the sealed insulating space, and the directing of the gas molecules by the variable-distance portion of the first and second walls imparting to the gas molecules a greater probability of egress from the sealed insulating space than ingress. The sealed insulating space of the first conduit can be, e.g., an Insulon™ space.

Embodiment 7. The insulated assembly of any of Embodiments 5-6, further comprising a fitting that seals the sealed insulating space of the first conduit, the fitting optionally comprising a portion that extends into the sealed insulating space. The distance between the flange and a tube of the conduit can be variable in a portion of the sealed insulating space adjacent the vent such that gas molecules within the sealed insulating space are directed towards the vent by the variable-distance portion.

Embodiment 8. The insulated assembly of any of Embodiments 1-7, wherein the second conduit comprises a second inner tube and a second outer tube, the first inner tube and the first outer tube defining a sealed insulating space therebetween.

Embodiment 9. The insulated assembly of Embodiment 8, further comprising a vent communicating with the sealed insulating space of the second conduit so as to provide an exit pathway for gas molecules from the sealed insulating space, the vent being sealable for maintaining a vacuum within the sealed insulating space following evacuation of gas molecules through the vent, the distance between the first and second walls being variable in a portion of the sealed insulating space adjacent the vent such that gas molecules within the sealed insulating space are directed towards the vent by the variable-distance portion of the first and second walls during the evacuation of the sealed insulating space, and the directing of the gas molecules by the variable-distance portion of the first and second walls imparting to the gas molecules a greater probability of egress from the sealed insulating space than ingress.

Embodiment 10. The insulated assembly of any of Embodiments 8-9, further comprising a fitting that seals the sealed insulating space of the first conduit, the fitting optionally comprising a portion that extends into the sealed insulating space.

Embodiment 11. The insulated assembly of any of Embodiments 1-10, wherein the inner jacket and the first conduit define a sealed space therebetween. This space can provide thermal insulation as well as fluid containment.

Embodiment 12. The insulated assembly of any of Embodiments 1-11, wherein the inner jacket and the second conduit define a sealed space therebetween.

Embodiment 13. The insulated assembly of any of Embodiments 1-12, wherein, as measured along the major axis of the lumen of the jacket, the first conduit defines a length, the second conduit defines a length, and the jacket insulating space overlies from 1 to about 10% of the length of at least one of the first conduit and the second conduit.

Embodiment 14. A method, comprising: communicating a fluid through the lumen of the first conduit and the lumen of the second conduit of an insulated assembly according to any of Embodiments 1-13. The communicated fluid can be comparatively cold, e.g., below 0 deg. C. In some embodiments, the communicated fluid can be comparatively warm, e.g., above 100 deg. C.

Embodiment 15. A method, comprising: with (a) a jacket assembly that comprises (i) an outer jacket secured to a first threaded fitting and (ii) an inner jacket secured to the first threaded fitting, the inner jacket defining a jacket lumen therein, the jacket lumen defining a major axis, the outer jacket and the inner jacket also defining a sealed jacket insulating space therebetween, a vent communicating with the jacket insulating space to provide an exit pathway for gas molecules from the jacket insulating space, the vent being sealable for maintaining a vacuum within the jacket insulating space following evacuation of gas molecules through the vent, the distance between the first and second walls optionally being variable in a portion of the jacket insulating space adjacent the vent such that gas molecules within the jacket insulating space are directed towards the vent by the variable-distance portion of the first and second walls during the evacuation of the jacket insulating space, the directing of the gas molecules by the variable-distance portion of the first and second walls imparting to the gas molecules a greater probability of egress from the jacket insulating space than ingress; (b) a first conduit defining a first lumen; (c) a second conduit defining a second lumen, the lumen of the second conduit and the lumen of the first conduit being in fluid communication with one another; and, (d) optionally, a sealer disposed between and end of the first conduit and an end of the second conduit, the sealer being in fluid communication with the first lumen and with the second lumen, placing the first lumen into fluid communication with the second lumen (which can be done sealably), and sealably securing the jacket assembly to one or both of the first and second conduits such that, as measured along the major axis of the lumen of the jacket, the jacket insulating space overlies at least a portion of the first conduit and at least a portion of the second conduit.

As explained, the distance between the first and second walls can be variable in a portion of the jacket insulating space adjacent the vent such that gas molecules within the jacket insulating space are directed towards the vent by the variable-distance portion of the first and second walls during the evacuation of the jacket insulating space, the directing of the gas molecules by the variable-distance portion of the first and second walls imparting to the gas molecules a greater probability of egress from the jacket insulating space than ingress. This is not a requirement, but it is considered especially suitable.

Embodiment 16. The method of Embodiment 15, wherein the sealably securing is effected by engaging the first threaded fitting with a first ferrule, the engagement optionally being effected by a threaded nut that engages with the first threaded fitting.

Embodiment 17. The method of any of Embodiments 15-16, wherein the sealably securing is effected such that the inner jacket and first conduit define a space therebetween.

Embodiment 18. The method of any of Embodiments 15-17, wherein the outer jacket is secured to a second threaded fitting and the inner jacket is secured to the second threaded fitting, further comprising engaging the second threaded fitting with a second ferrule so as to secure the jacket assembly to the second conduit, the engagement optionally being effected by a threaded nut that engages with the second threaded fitting.

Embodiment 19. The method of Embodiment 18, wherein the sealably securing is effected such that the inner jacket and second conduit define a space therebetween.

Embodiment 20. The method of any of Embodiments 15-19, wherein one or both of the first and second conduits comprises an inner wall and an outer wall that define an insulating space therebetween, a vent communicating with the jacket insulating space to provide an exit pathway for gas molecules from the jacket insulating space, the vent being sealable (e.g., for maintaining a reduced pressure, such as a vacuum) within the jacket insulating space following evacuation of gas molecules through the vent, the distance between the first and second walls optionally being variable in a portion of the jacket insulating space adjacent the vent such that gas molecules within the jacket insulating space are directed towards the vent by the variable-distance portion of the first and second walls during the evacuation of the jacket insulating space, and the directing of the gas molecules by the variable-distance portion of the first and second walls imparting to the gas molecules a greater probability of egress from the jacket insulating space than ingress.

As explained, the distance between the first and second walls can be variable in a portion of the jacket insulating space adjacent the vent such that gas molecules within the jacket insulating space are directed towards the vent by the variable-distance portion of the first and second walls during the evacuation of the jacket insulating space, the directing of the gas molecules by the variable-distance portion of the first and second walls imparting to the gas molecules a greater probability of egress from the jacket insulating space than ingress. This is not a requirement, but it is considered especially suitable.

1. An insulated assembly, comprising:
(a) a jacket assembly that comprises (i) an outer jacket secured to a first threaded fitting and (ii) an inner jacket secured to the first threaded fitting,
the inner jacket defining a jacket lumen therein, the jacket lumen defining a major axis, the outer jacket and the inner jacket also defining a sealed, evacuated jacket insulating space therebetween,
a vent communicating with the jacket insulating space to provide an exit pathway for gas molecules from the jacket insulating space,
the vent being sealable for maintaining a vacuum within the jacket insulating space following evacuation of gas molecules through the vent,
the distance between the first and second walls optionally being variable in a portion of the jacket insulating space adjacent the vent such that gas molecules within the jacket insulating space are directed towards the vent by the variable-distance portion of the first and second walls during the evacuation of the jacket insulating space,
the directing of the gas molecules by the variable-distance portion of the first and second walls imparting to the gas molecules a greater probability of egress from the jacket insulating space than ingress;
(b) a first conduit defining a first lumen;
(c) a second conduit defining a second lumen, the lumen of the second conduit and the lumen of the first conduit being in fluid communication with one another; and,
(d) optionally, a sealer disposed between an end of the first conduit and an end of the second conduit, the sealer being in fluid communication with the first lumen and with the second lumen,
(e) the jacket assembly being sealably secured to the first conduit and the second conduit, and
(f) as measured along the major axis of the lumen of the jacket, the jacket insulating space overlying at least a portion of the first conduit and at least a portion of the second conduit.

2. The insulated assembly of claim 1, further comprising a first threaded nut that encircles the first conduit and a first ferrule that encircles the first conduit, the first threaded nut engaging with the first threaded fitting such that the first ferrule sealably secures the jacket assembly to the first conduit.

3. The insulated assembly of any of claims 1-2, wherein the outer jacket is secured to a second threaded fitting and the inner jacket is secured to the second threaded fitting, and wherein the insulated assembly further comprises a second threaded nut that encircles the second conduit and a second ferrule that encircles the second conduit, the second threaded nut engaging with the second threaded fitting such that the second ferrule sealably secures the jacket assembly to the second conduit.

4. The insulated assembly of claim 1, wherein the first and second lumens are coaxial with one another.

5. The insulated assembly of claim 1, wherein the first conduit comprises a first inner tube and a first outer tube, the first inner tube and the first outer tube defining a sealed insulating space therebetween.

6. The insulated assembly of claim 5, further comprising a vent communicating with the sealed insulating space of the first conduit so as to provide an exit pathway for gas molecules from the sealed insulating space,
the vent being sealable for maintaining a vacuum within the sealed insulating space following evacuation of gas molecules through the vent, the distance between the first and second walls being variable in a portion of the sealed insulating space adjacent the vent such that gas molecules within the sealed insulating space are directed towards the vent by the variable-distance portion of the first and second walls during the evacuation of the sealed insulating space, and
the directing of the gas molecules by the variable-distance portion of the first and second walls imparting to the gas molecules a greater probability of egress from the sealed insulating space than ingress.

7. The insulated assembly of claim 5, further comprising a fitting that seals the sealed insulating space of the first conduit, the fitting optionally comprising a portion that extends into the sealed insulating space.

8. The insulated assembly of claim 1, wherein the second conduit comprises a second inner tube and a second outer tube, the first inner tube and the first outer tube defining a sealed insulating space therebetween.

9. The insulated assembly of claim 8, further comprising a vent communicating with the sealed insulating space of the second conduit so as to provide an exit pathway for gas molecules from the sealed insulating space,
the vent being sealable for maintaining a vacuum within the sealed insulating space following evacuation of gas molecules through the vent, the distance between the first and second walls being variable in a portion of the sealed insulating space adjacent the vent such that gas molecules within the sealed insulating space are directed towards the vent by the variable-distance portion of the first and second walls during the evacuation of the sealed insulating space, and
the directing of the gas molecules by the variable-distance portion of the first and second walls imparting to the gas molecules a greater probability of egress from the sealed insulating space than ingress.

10. The insulated assembly of claim 8, further comprising a fitting that seals the sealed insulating space of the first conduit, the fitting optionally comprising a portion that extends into the sealed insulating space.

11. The insulated assembly of claim 1, wherein the inner jacket and the first conduit define a sealed space therebetween.

12. The insulated assembly of claim 1, wherein the inner jacket and the second conduit define a sealed space therebetween.

13. The insulated assembly of claim 1, wherein, as measured along the major axis of the lumen of the jacket, the first conduit defines a length, the second conduit defines a length, and the jacket insulating space overlies from 1 to about 10% of the length of at least one of the first conduit and the second conduit.

14. A method, comprising: communicating a fluid through the lumen of the first conduit and the lumen of the second conduit of an insulated assembly according to claim 1.

15. A method, comprising:
with (a) a jacket assembly that comprises (i) an outer jacket secured to a first threaded fitting and (ii) an inner jacket secured to the first threaded fitting,
the inner jacket defining a jacket lumen therein, the jacket lumen defining a major axis,
the outer jacket and the inner jacket also defining a sealed jacket insulating space therebetween,
a vent communicating with the jacket insulating space to provide an exit pathway for gas molecules from the jacket insulating space,
the vent being sealable for maintaining a vacuum within the jacket insulating space following evacuation of gas molecules through the vent,
the distance between the first and second walls optionally being variable in a portion of the jacket insulating space adjacent the vent such that gas molecules within the jacket insulating space are directed towards the vent by the variable-distance portion of the first and second walls during the evacuation of the jacket insulating space,
the directing of the gas molecules by the variable-distance portion of the first and second walls imparting to the gas molecules a greater probability of egress from the jacket insulating space than ingress;
(b) a first conduit defining a first lumen;
(c) a second conduit defining a second lumen, the lumen of the second conduit and the lumen of the first conduit being in fluid communication with one another; and,
(d) optionally, a sealer disposed between and end of the first conduit and an end of the second conduit, the sealer being in fluid communication with the first lumen and with the second lumen,
placing the first lumen into fluid communication with the second lumen, and
sealably securing the jacket assembly to one or both of the first and second conduits such that, as measured along the major axis of the lumen of the jacket, the jacket insulating space overlies at least a portion of the first conduit and at least a portion of the second conduit.

16. The method of claim 15, wherein the sealably securing is effected by engaging the first threaded fitting with a first ferrule, the engagement optionally being effected by a threaded nut that engages with the first threaded fitting.

17. The method of claim 15, wherein the sealably securing is effected such that the inner jacket and first conduit define a space therebetween.

18. The method of claim 15, wherein the outer jacket is secured to a second threaded fitting and the inner jacket is secured to the second threaded fitting, further comprising engaging the second threaded fitting with a second ferrule so as to secure the jacket assembly to the second conduit, the engagement optionally being effected by a threaded nut that engages with the second threaded fitting.

19. The method of claim 18, wherein the sealably securing is effected such that the inner jacket and second conduit define a space therebetween.

20. The method of claim 15, wherein one or both of the first and second conduits comprises
an inner wall and an outer wall that define an insulating space therebetween,
a vent communicating with the jacket insulating space to provide an exit pathway for gas molecules from the jacket insulating space,
the vent being sealable for maintaining a vacuum within the jacket insulating space following evacuation of gas molecules through the vent,
the distance between the first and second walls optionally being variable in a portion of the jacket insulating space adjacent the vent such that gas molecules within the jacket insulating space are directed towards the vent by the variable-distance portion of the first and second walls during the evacuation of the jacket insulating space, and
the directing of the gas molecules by the variable-distance portion of the first and second walls imparting to the gas molecules a greater probability of egress from the jacket insulating space than ingress.
